(19) United States
(12) Patent Application Publication
(10) Pub. No.: US 2012/0055351 A1
(43) Pub. Date: Mar. 8, 2012

(54) Juice Extractor

(76) Inventor: Caixia WO, Foshan City (CN)

(21) Appl. No.: 13/214,313

(22) Filed: Aug. 22, 2011

(30) Foreign Application Priority Data
Sep. 3, 2010 (CN) 201020518349.1

(51) Int. Cl. A23N 1/00

(52) U.S. Cl. 99/509

(57) ABSTRACT

The invention discloses a juice extractor, which comprises a machine body, a fruit juice cup, a top cover and a push rod, wherein the machine body is arranged on a pedestal; a power unit is arranged inside the machine body; a filter screen and a spiral cutter are sleeved inside the fruit juice cup which is provided with a residue outlet and a juice outlet; the top cover for the fruit juice cup is provided with an inlet formed on one side of the top cover for the fruit juice cup and a rotary shaft hole formed on the center of an inner part of the top cover for the fruit juice cup; the spiral cutter consists of a screw and screw spirals; the screw is provided with an upper rotary shaft and a lower rotary shaft; the screw spirals are formed on the outer surface of the screw; and the spiral end face of the upper rotary shaft is a double-spiral notch formed by two symmetrically arranged tangent planes. As the juice extractor adopting the proposal employs a double-spiral screw structure, the juice yield of the juice extractor reaches up to 85 percent; not only the nutrient contents of fruit is fully retained but also the work efficiency of the juice extractor is higher than that of other fruit extractors; and the variety of fruit which can be extracted is higher. Moreover, due to the adoption of the screw with the structure, the noise can be further reduced; the service life of the screw can be prolonged; and energy conservation and environmental protection can be achieved.

### FIELD OF THE INVENTION

The invention relates to a juice extractor for extracting juice from fruit, vegetables or beans and peas.

### BACKGROUND OF THE INVENTION

As vitamins can be usually destroyed at high temperature, human beings usually cannot fully absorb overall fruit and vegetable nutrients of cooked vegetables. Due to the invention of juice extractors, fruit and vegetables can be extracted into fruit and vegetable juice. Therefore, not only the fruit and vegetable juice is natural but also fewer vitamins can be destroyed. Moreover, the burden of stomach can also be eased.

The prior juice extractor is usually run by means of high-speed cutting or squeezing and centrifugal separation. The working mode has the disadvantages that: not only the original flavor can be easily destroyed but also nutrients can be destroyed due to instantaneous high temperature generated by high speed, consequently a great quantity of beneficial ingredients are lost. In particular, the juice yield of the juice extractor is very low when the juice extractor is used for extracting juice from high-viscosity fruit or beans and peas.

A juice extractor employing a screw to squeeze at very low speed is also adopted currently. The juice extractor has the advantages that: not only the juice can be prevented from being stale but also the nutrition can be fully guaranteed. In particular, the juice yield of the juice extractor is far higher than that of the prior high-speed juice extractor. Moreover, due to the structure, the juice extractor is conductive to cleaning. However, the technical requirements of the juice extractor on the screw are very high and different screw designs will have a huge impact on the efficiency of the juice extractor.

### SUMMARY OF THE INVENTION

In order to solve the problems, the invention provides a juice extractor with higher juice yield and faster juice extraction speed.

In order to achieve the technical object, the invention adopts the proposal that: the invention relates to a juice extractor, which comprises a machine body, a fruit juice cup, a top cover for the fruit juice cup, and a push rod, wherein the machine body is arranged on a pedestal; a power unit is arranged inside the machine body; the fruit juice cup can be assembled and disassembled on the machine body; a filter screen and a spiral cutter are sleeved inside the fruit juice cup; the spiral cutter is transmissibly connected with the power unit through a convex through hole at the bottom of the fruit juice cup; the fruit juice cup is provided with a residue outlet port and a juice outlet port; the top cover for the fruit juice cup is provided with an inlet port formed on one side of the top cover for the fruit juice cup and a rotary shaft hole formed on the center of an inner part of the top cover for the fruit juice cup; the spiral cutter consists of a screw and screw spirals; the screw is provided with an upper rotary shaft and a lower rotary shaft; the screw spirals are formed on the outer surface of the screw; the upper rotary shaft of the screw is inserted into the rotary shaft hole, and the lower rotary shaft of the screw is transmissibly connected to the power unit; and the spiral end face of the upper rotary shaft is a double-spiral notch formed by two symmetrically arranged tangent planes.

Preferably, the inside of the fruit juice cup is also provided with a middle ring which is sleeved outside the filter screen.

Preferably, a pair of cleaning foils are symmetrically arranged between the fruit juice cup and the filter screen.

Preferably, the power unit consists of a motor and a gear box which are fixedly connected with each other.

As the juice extractor adopting the proposal employs a double-spiral screw structure, the juice yield of the juice extractor reaches up to 85 percent; not only the nutrient contents of fruit is fully retained but also the work efficiency of the juice extractor is higher than that of other fruit extractors; and the variety of fruit which can be extracted is higher. Moreover, due to the adoption of the screw with the structure, the noise can be further reduced; the service life of the screw can be prolonged; and energy conservation and environmental protection can be achieved.

### BRIEF DESCRIPTION OF THE DRAWINGS

FIG. 1 is an exploded diagram of the embodiment of the invention; and

FIG. 2 is a structural diagram of a spiral cutter in the embodiment of the invention.

### DETAILED DESCRIPTION OF THE PREFERRED EMBODIMENTS

Further detailed description is given to the invention with the accompanying drawings and the preferred embodiment.

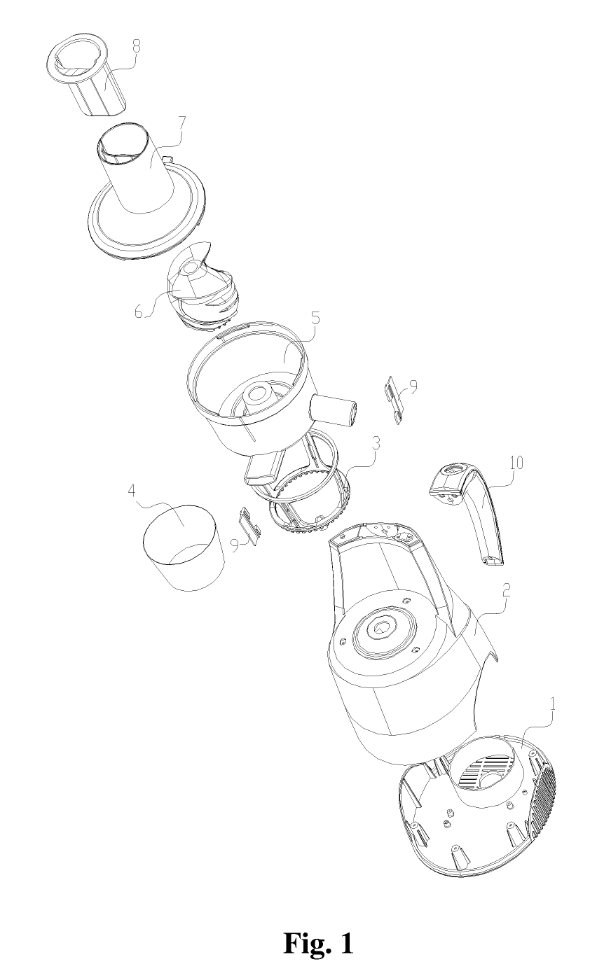

As illustrated in FIG. 1, a juice extractor of the preferred embodiment comprises a machine body 2, a fruit juice cup 5, a top cover for the fruit juice cup 7, and a push rod 8, wherein the machine body 2 is arranged on a pedestal 1; a power unit is arranged inside the machine body 2 and consists of a motor and a gear box which are fixedly connected with each other (the power unit is not shown in the figure and can be other power unit with a well-known structure); the fruit juice cup 5 can be assembled and disassembled on the machine body 2; the push rod 8 is used for pushing in materials to be extracted; a filter screen 4 and a spiral cutter 6 are sleeved inside the fruit juice cup 5; the inside of the fruit juice cup 5 is also provided with a middle ring 3 which is sleeved outside the filter screen 4; a pair of cleaning foils 9 are symmetrically arranged between the fruit juice cup 5 and the filter screen 4; the spiral cutter 6 is transmissibly connected with the power unit through a convex through hole at the bottom of the fruit juice cup 5; and the fruit juice cup 5 is provided with a residue outlet port and a juice outlet port; the top cover for the fruit juice cup 7 is provided with an inlet port formed on one side of the top cover for the fruit juice cup 7 and a rotary shaft hole formed on the center of an inner part of the top cover for the fruit juice cup 7.

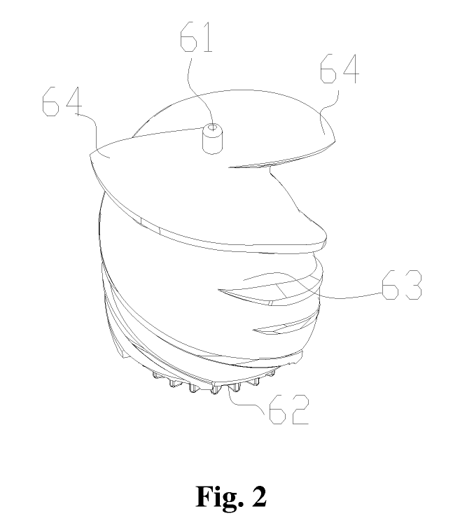

As illustrated in FIG. 2, the spiral cutter 6 consists of a screw and screw spirals 63, wherein the screw is provided with an upper rotary shaft 61 and a lower rotary shaft 62; the screw spirals 63 are formed on the outer surface of the screw; the upper rotary shaft 61 of the screw can be inserted into the rotary shaft hole in the middle of the top cover for the fruit juice cup 7; and the lower rotary shaft 62 of the screw is transmissibly connected to the power unit to drive the whole spiral cutter to rotate. As the screw is bidirectionally fixed, the vibration of the spiral cutter 6 is prevented during the operation of the screw, and the shaking or striking of the spiral cutter 6 against the internal wall of the filter screen 4 is also prevented. Therefore, less noise is generated; the abrasion of the screw is prevented; and the service life of the equipment is greatly prolonged.

In particular, as illustrated in FIG. 2, the spiral end face of the upper rotary shaft 61 is a double-spiral notch formed by two symmetrically arranged tangent planes 64. Due to the double-spiral notch structure, the materials to be extracted are more efficiently cut and driven to naturally move down under the action of the gravity and the rotation of the screw, consequently the juice extraction speed is improved. Accordingly, the extracted juice will flow down better and will not remain in a housing.

As the preferred embodiment, a sloping surface can be formed on one side of the lower surface of the top cover for the fruit juice cup 7 of the juice extractor, so that the materials to be extracted can be automatically fed into the inlet port without being pressed down.

According to the juice extractor as constructed above according to the invention, the screw is adopted to perform low-speed squeezing instead of adopting an adjustable rotating blade for squeezing, so that various nutrients and intrinsic flavor contained in juice, soybean milk and so on are maintained to the fullest extent, and extensive juice extraction become possible irrespective of the variety of fruit and vegetables.

The above only gives detailed description to the preferred embodiment of the invention and is not used to limit the invention. Any minor change, equivalent replacement and improvement made on the embodiment based on the technical substance of the invention shall be within the scope of protection of the technical proposal of the invention.

What is claimed is:

1. A juice extractor, comprising a machine body, a fruit juice cup, a top cover for the fruit juice cup, and a push rod, wherein the machine body arranged on a pedestal; a power unit arranged inside the machine body; the fruit juice cup being capable of being assembled and disassembled on the machine body; a filter screen and a spiral cutter sleeved inside the fruit juice cup; the spiral cutter transmissibly connected with the power unit through a convex through hole at the bottom of the fruit juice cup; the fruit juice cup provided with a residue outlet port and a juice outlet port; the top cover for the fruit juice cup provided with an inlet port formed on one side of the top cover for the fruit juice cup and a rotary shaft hole formed on the center of an inner part of the top cover for the fruit juice cup; the spiral cutter consisting of a screw and screw spirals; the screw provided with an upper rotary shaft and a lower rotary shaft; the screw spirals formed on the outer surface of the screw; the upper rotary shaft of the screw inserted into the rotary shaft hole, and the lower rotary shaft of the screw transmissibly connected to the power unit; and the spiral end face of the upper rotary shaft being a double-spiral notch formed by two symmetrically arranged tangent planes.

2. The juice extractor according to claim 1, wherein the inside of the fruit juice cup is also provided with a middle ring which is sleeved outside the filter screen.

3. The juice extractor according to claim 1, wherein a pair of cleaning foils are symmetrically arranged between the fruit juice cup and the filter screen.

4. The juice extractor according to claim 1, wherein the power unit consists of a motor and a gear box which are fixedly connected with each other.
